(19) United States
(12) Patent Application Publication
(10) Pub. No.: US 2012/0054621 A1
(43) Pub. Date: Mar. 1, 2012

(54) AUDIO FEEDBACK AND DEPENDENCY ON LIGHT FUNCTIONALITY AND SETTING

(75) Inventor: Thomas J. G. Pelzer, Kerkrade (NL)

(73) Assignee: KONINKLIJKE PHILIPS ELECTRONICS N.V., EINDHOVEN (NL)

(21) Appl. No.: 13/320,035

(22) PCT Filed: May 6, 2010
(86) PCT No.: PCT/IB10/51992

§ 371 Date: Nov. 11, 2011

(30) Foreign Application Priority Data
May 13, 2009 (EP) 09160100.5

(51) Int. Cl. G06F 3/16; G06F 3/048

(52) U.S. Cl. 715/727

(57) ABSTRACT

The present invention provides a control device (1) for providing audio feedback in response to control of visual parameters, said control device comprising an audio signal transmitter, a user interface (3) for controlling the visual parameters, a communication unit (2) adapted to control the visual parameters by means of communicating control signals effected by said user interface being operated by a user, such that the audio signal transmitter transmits an audio signal in reply to the control of an associated visual parameter by means of the user interface being operated, a characteristic of which audio signal being arranged such that the signal audibly identifies the controlled visual parameter.

### FIELD OF THE INVENTION

The present invention relates to providing audio feedback in response to activation of visual parameters.

### BACKGROUND OF THE INVENTION

For the control of many types of devices such as e.g. computers, television sets, various types of handheld devices, technical instruments etc., the interaction between the device and the user in form of interfaces is evolving to meet the demands of the user striving for easier, better and more efficient control. Today, user interfaces are becoming increasingly more sophisticated in order to allow consumers to take advantage of the recent technological developments.

Generally, user interfaces are embodied by means of physical buttons or physical mechanisms to control certain functionalities. The nature of these types of controls provides several types of feedback such as tactile (e.g. a click feel) and audio feedback (e.g. a click sound). These responses assure the user that an action has been performed.

However, with the development of interfaces, different types of means to execute commands have evolved, such as e.g. touch sensitive areas. By this, the above-mentioned feedback is lost. To compensate for this loss, other forms of confirmations on actions taken are often incorporated into these user interfaces devoted to attract the user's attention such as audible, visual and vibrational feedback.

One example of such a user interface is disclosed in WO2007/105134, relating to a control device for controlling the color of light emitted from a light source. The device comprises color variation means with one or more light-emitting elements arranged to indicate an available color variation range for the color of the light emitted from the source. Thus, the device provides a controlling of the color of light that is easy to use and intuitive in its operation.

### SUMMARY OF THE INVENTION

It is an object of the present invention to provide an improved feedback to a user.

According to a first aspect of the present invention, this is realized by a method providing audio feedback in response to control of visual parameters, the method comprising the steps of generating an audio signal in reply to the control of an associated visual parameter among a plurality of visual parameters, a characteristic of which audio signal being arranged such that the signal audibly identifies the controlled visual parameter.

According to a second aspect of the present invention, the above-mentioned and other objects are achieved through a control device providing audio feedback in response to control of visual parameters, wherein the user interface comprises an audio signal transmitter, a user interface for controlling the visual parameters and a communication unit adapted to control the visual parameters by means of communicating control signals effected by said user interface being operated by a user. Further, the audio signal transmitter transmits an audio signal in reply to the control of an associated visual parameter by means of the user interface being operated, a characteristic of which audio signal being arranged such that the signal audibly identifies the controlled visual parameter.

The term “audio signal” should, in this context, be construed as a signal, sound, alert or the like, audible for humans.

The feedback provided guides a user operating the control device by means of an audio signal unique for each visual parameter, i.e. the particular type of signal can be recognized by the user as belonging to a certain parameter. A change of visual parameter renders a change of signal in order to notify a user operating the control device of the parameter to which a change is made. For visually impaired users, or when operation is performed under dark, non-illuminated conditions, audio feedback creates an added value in the provided feedback.

The visual parameters, for which feedback is provided, typically comprise any one of hue, saturation, brightness, color temperature, timing properties or any other appropriate visual parameter. These parameters are typically controlled by a user operating a proper touch sensitive user interface on the control device of the present invention. As an example, this user interface may be a touch sensitive ring. In an example, the visual parameters represent properties of light emitted from a light source. Thus, the control device of the present invention may be used to remotely control, via a communication unit of the control device, the properties of light emitted from one or more light sources of outdoor or indoor lighting applications, especially professional indoor lighting applications aimed at shops, offices, hotels, etc.

Additionally, the feedback audio signal may identify the controlled visual parameter by means of a particular type of sound such as a click, beep or tick sound, in terms of signal pitch, in terms of signal volume or a combination thereof, provided via an audio signal transmitter of the control device. The different types of unique sounds vouch for a clear distinction between the associated visual parameters, such that any one—or the combination of—the type of sound, the pitch of the sound or the volume of the sound may be recognized as belonging to a certain parameter. As an example, when controlling the hue functionality, the user interface may provide a click sound whereas for saturation and brightness, a beep sound and a tick sound, respectively, may be provided. Alternatively, to further distinguish an associated visual parameter, any combination of sound and signal features may be applied. As an example, when controlling the hue functionality, the user interface may provide a low pitch, low volume click sound whereas for saturation, a medium pitch, medium volume beep sound may be provided and for brightness, a high pitch, high volume tick sound may be provided.

According to one embodiment, the audio signal volume may be controlled in response to the particular setting of the controlled visual parameter such that the audio signal volume audibly identifies the particular setting. By this, a change of the particular setting of the parameter renders a signal volume variation as feedback of the change. As an example, if saturation is selected, a higher volume level of the audio feedback may be provided when a higher saturation setting is selected. Analogously, the user interface may provide a lower volume level of the audio feedback when a lower saturation setting is selected.

In a further embodiment, the audio signal volume may be varied between two extreme values in response to the controlled visual parameter varying between its two extreme values. By this, a low parameter setting may correspond to a low volume audio feedback, which adds meaning to the audio feedback. To ensure the comfort for the user and to establish conditions for the distinction of a setting for the user, the control device should provide a feedback where the minimum volume, corresponding to a minimum parameter setting, should be audible to users whereas the maximum volume, corresponding to a maximum parameter setting, should not be too loud. Furthermore, the difference between the maximum and the minimum volume should be sufficiently evident for users to hear a shift in volume in the complete range. However, it should be noted that this type of audio feedback is adapted for functionalities that have a distinct minimum and maximum setting, or start and end, such as brightness and saturation. With hue for example, the function would be less intuitive, as this parameter neither has a minimum nor a maximum, nor any start or end.

According to one embodiment, audio feedback may be deactivated if attempts are made to set the controlled visual parameter to a value outside the range defined by its two extreme values. The feature informs the user that a limit has been reached for the setting, i.e.

that the audio feedback stops when a limit has been reached, even when the user tries to go beyond this limit by decreasing or increasing the value of the parameter setting.

Further, the varying of the audio signal volume is proportional to the varying of the controlled visual parameter value. This embodiment contributes to the distinction of the feedback related to the controlled visual parameter value.

Additionally, the audio signal volume may be linear to the varying of the controlled visual parameter value. Such a linear relationship in volume may supply the user with a clear and easily recognizable feedback regarding the variation of the controlled visual parameter value.

Alternatively, the audio signal volume may be non-linear to the varying of the controlled visual parameter value. A non-linear function in the volume may further distinguish the volume feedback regarding the variation of the controlled visual parameter value.

According to yet another exemplifying embodiment of the present invention, the touch-sensitive control of the user interface comprises at least one discontinuity-indicating element adapted to visually indicate a step discontinuity in a range of available values representing the controlled visual parameter.

Such a configuration enables implementation of a so called “hard transition” in the range of available values representing the currently controlled visual parameter.

In the context of the present invention, by the term “hard transition” it is meant a portion of the touch-sensitive control that indicates to the user the presence of a step discontinuity in the range of available values representing the controlled visual parameter, for example between extreme values in the range of available values representing the parameter.

Such a configuration according to the embodiment described immediately above enables representing a visual parameter having a range of available values delimited by two extreme values, such as brightness, saturation, color temperature, etc. In this manner, the beginning (e.g., minimum) and the end (e.g., maximum) of the available values may be clearly communicated to the user, whereby a more user-intuitive user interface may be provided, and consequently the user friendliness may be further increased. According to one embodiment, a computer program product comprising computer-executable components for causing a device to perform the above described functions may be provided, when the computer-executable components are run on a processing unit included in the device.

Further features of, and advantages with, the present invention will become apparent when studying the appended claims and the following description. Those skilled in the art realize that different features of the present invention can be combined to create embodiments other than those described in the following.

### BRIEF DESCRIPTION OF THE DRAWINGS

These and other aspects of the present invention will now be described more in detail, with reference to the appended drawings.

FIGS. 1a-b schematically illustrate the communication between the control device and the device to be controlled.

FIG. 2 shows a schematic view of the control device according to an exemplifying embodiment of the present invention.

FIG. 3 is a diagram of the audio character or frequency type as a function of functionality.

FIGS. 4a-b are diagrams of the audio signal feedback volume as a function of functionality level.

FIG. 5 is a diagram of a combination between the type of audio signal.

FIG. 6a-c show operations on a user interface for a functionality level setting.

FIG. 7 is a diagram of the audio signal feedback as a function of functionality level.

FIG. 8 shows a user interface comprising a hard transition touch sensitive ring.

### DETAILED DESCRIPTION

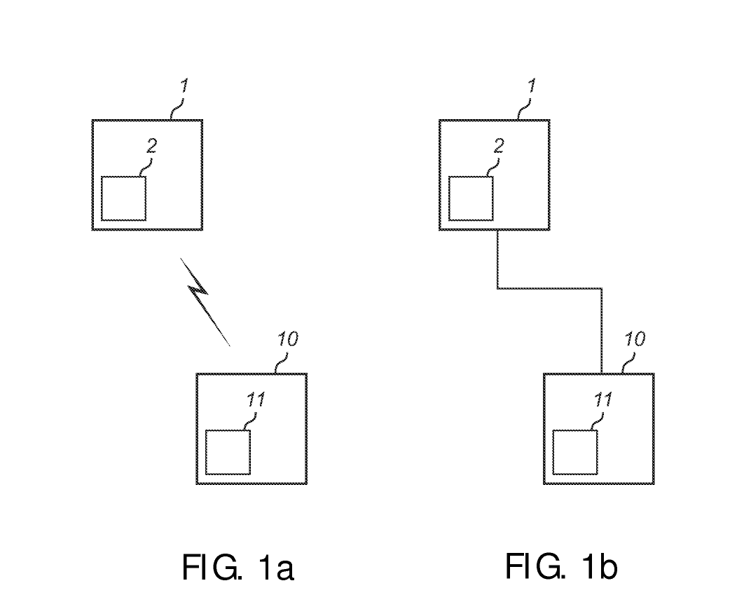

Referring to FIG. 1a, there is shown a schematic block diagram of a control device 1 according to an exemplifying embodiment of the present invention. The control device 1 may comprise a communication unit 2 adapted to communicate control signals, corresponding to user input on the control device 1, via wireless communications to a device to be controlled, e.g. a television set, a dimmable window or a light source 10. In the following example, the device to be controlled will come in the form of a light source. The light source 10 may in turn comprise a communication unit 11 adapted to receive control signals communicated from the communication unit 2 of the control device 1, on the basis of which control signals visual parameters in the form of properties of light emitted from the light source 10 may be adjusted.

Referring now to FIG. 1b, there is shown a schematic block diagram of a control device 1 according to another exemplifying embodiment of the present invention. The control device 1 may comprise a communication unit 2 adapted to communicate control signals, corresponding to user input on the control device 1, via communication wires to a light source 10. The light source 10 may in turn comprise a communication unit 11 adapted to receive control signals communicated from the communication unit 2 of the control device 1, on the basis of which control signals properties of light emitted from the light source 10 may be adjusted.

Thus, with reference to FIGS. 1a-1b, the communication unit 2 of the control device 1 may be adapted to communicate control signals to the light source 10 (or to the communication unit 11 of the light source 10) in a wired fashion (e.g. by means of Ethernet, lighting control systems such as Digital Addressable Lighting Interface (DALI), DMX (such as DMX512), etc.) or in a non-wired fashion (e.g. by means of wireless infra-red (IR) communications or other wireless optical communications, or by means of wireless radiowave communications). As such techniques are known in the art, detailed description thereof is omitted. The control device 1 may also be implemented in a docking station (not shown) integrated with or external to the light source 10, comprising e.g. a luminaire, that the control device 1 is intended to control. On one hand, the communication unit 2 may in such a case communicate control signals to the light source 10 via the docking station when the control device 1 is docked in the docking station. On the other hand, when the control device 1 is not docked in the docking station, the communication unit 2 may for example communicate control signals to the light source 10 (or to the communication unit 11 of the light source 10) in a wired or non-wired fashion such as has been described in the foregoing. It should further be noted that the control device 1 may be an integrated part of for example a portable media player thus being able to control visual parameters of the media player display screen.

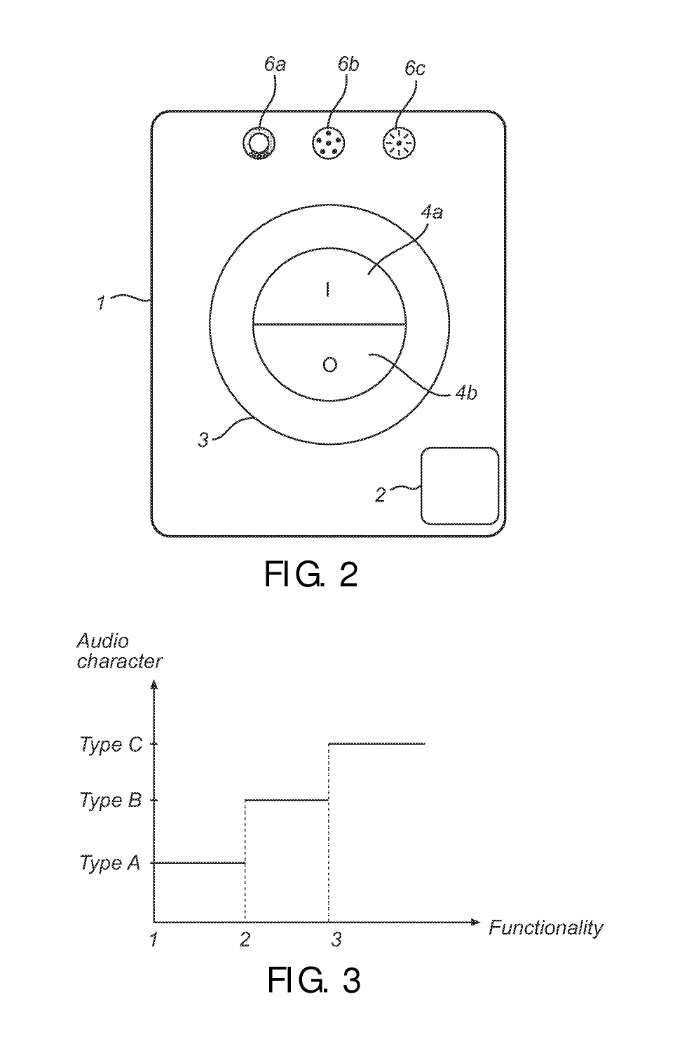

Referring to FIG. 2, there is shown a schematic view of a control device 1 according to an exemplifying embodiment of the present invention. The control device 1 comprises a touch-sensitive user interface 3. According to the depicted embodiment, the user interface 3 comprises a ring-shaped panel 5, sensitive to touch by a user, whereby the control device 1 is provided with user input. The touch-sensitive user interface 3 is adapted to visually indicate a range of available values representing at least one visual parameter, such as a property of light emitted by light source 10, and to enable a user to control the represented property on the basis of a location touched on the user interface 3. The control device 1 further comprises a communication unit 2 adapted to adjust the controlled property by means of communicating, to the light source 10, control signals corresponding to the user input. Moreover, the control device comprises an audio signal transmitter (not shown) which transmits an audio signal in reply to the control of a visual parameter by means of the user interface being operated, in order to audibly identify the controlled visual parameter. Though the user interface 3 described with reference to FIG. 2 comprises a ring-shaped panel 5, the user interface 3 may comprise shapes other than such a ring-formed shape while completely of partially achieving the advantages of the present invention. This is further described in the following.

The control device may further comprise an on-button 4a and an off-button 4b for powering up and powering down the control device 1, respectively.

With further reference to FIG. 2, the control device 1 may further comprise a plurality of controls, in this particular example in the form of touch-sensitive activation areas 6a, 6b, 6c. Each touch-sensitive activation area 6a, 6b, 6c may be associated with at least one of the properties of light emitted from the light source, e.g. hue, saturation, brightness, color temperature and timing properties, and each touch-sensitive activation area 6a, 6b, 6c may be adapted, when activated, to cause the control device 1 to enable the user to control the property associated with the respective activated touch-sensitive activation area 6a, 6b, 6c via the touch-sensitive user interface 3.

FIG. 3 shows an example of audio signal character as a function of particular visual settings. By selecting a first functionality 1 from the control device, a first audio type (Type A) is audible for the user. A change of the particular setting within the first functionality 1, which may be performed by tapping/sliding a user interface in the form of a touch sensitive ring of the control device, still generates the same audio type (Type A). For instance, a user may control a visual parameter such as brightness from very dark to very bright, while the audio transmitter of the control device generates e.g. a permanent beep sound in response thereto. The communication unit of the control device communicates control signals, effected by a user operating the user interface, to a device for which visual parameters should be controlled. Analogously, a selection of a second functionality 2 from the control device renders a second audio type (Type B), distinguishable from the first audio type, e.g. a tick sound. A change of the particular setting within the second functionality 2 generates the same audio type (Type B). A third functionality 3 renders a third audio type (Type C) distinguishable from the first (Type A) and the second (Type B) audio types, e.g. a click sound. A change of the particular setting within the third functionality 3 generates the same audio type (Type C). Hence, in this particular example, a change within a functionality yields a permanent character in the audio signal, whereas a change from one functionality to another renders a discontinuous and audibly detectable change in character, e.g. a different type of sound.

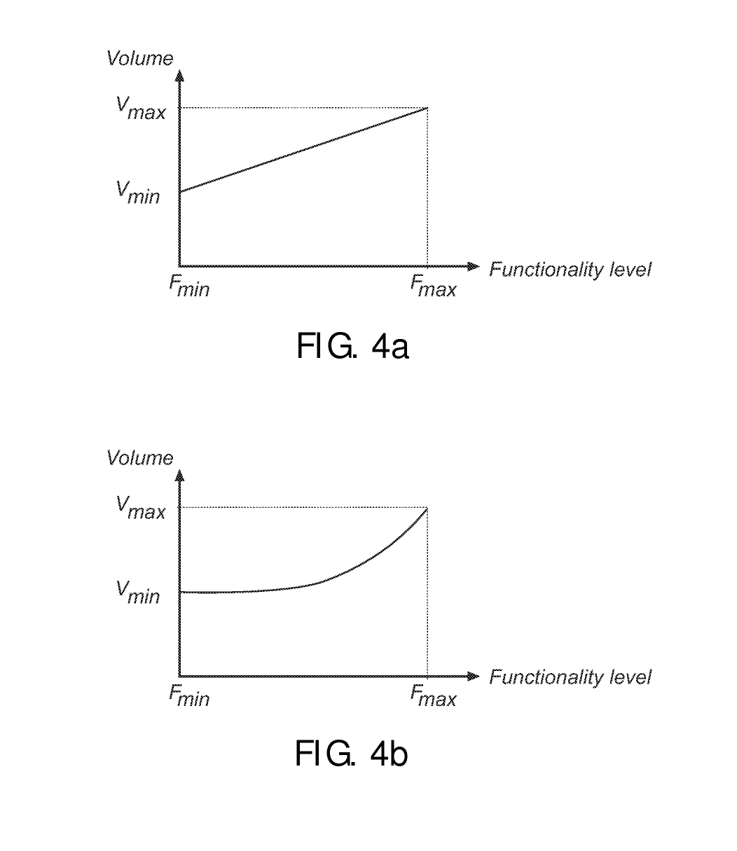

For a selected functionality, the volume of the audio signal fed back as a function of the particular selected functionality level is shown in FIG. 4. The minimum volume (Vₘᵢₙ) corresponds to a minimum level of a functionality (Fₘᵢₙ), and the maximum volume (Vₘₐₓ) corresponds to a maximum level of a functionality (Fₘₐₓ). In case of a visual parameter such as brightness, Vₘᵢₙ could denote “very dark”, while Vₘₐₓ may denote “very bright”. FIG. 4a shows a linear increase in volume with an increasing in functionality from the minimum level to the maximum level, which can be described in the following as

Volume=k*([Functionality level]−Fₘᵢₙ)+Vₘᵢₙ,

wherein

k=(Vₘₐₓ−Vₘᵢₙ)/(Fₘₐₓ−Fₘᵢₙ).

FIG. 4b shows a non-linear increase in audio signal volume as a function of selected functionality level. The volume increase is exponential as a function of change in functionality level and can therefore be described as

Volume=k*e^{([Functionality level]-Fmin)}+m

wherein

k=(Vₘₐₓ−Vₘᵢₙ)/(e^{(Fmax-Fmin)}−1)

and

m=Vₘᵢₙ−k=Vₘᵢₙ−(Vₘₐₓ−Vₘᵢₙ)/(e^{(Fmax-Fmin)}−1)

The minimum volume Vₘᵢₙ is still audible to users, whereas the maximum volume Vₘₐₓ is not too loud for users. The difference between the maximum and the minimum volume is sufficiently big for users to perceive a transition in volume from minimum to maximum.

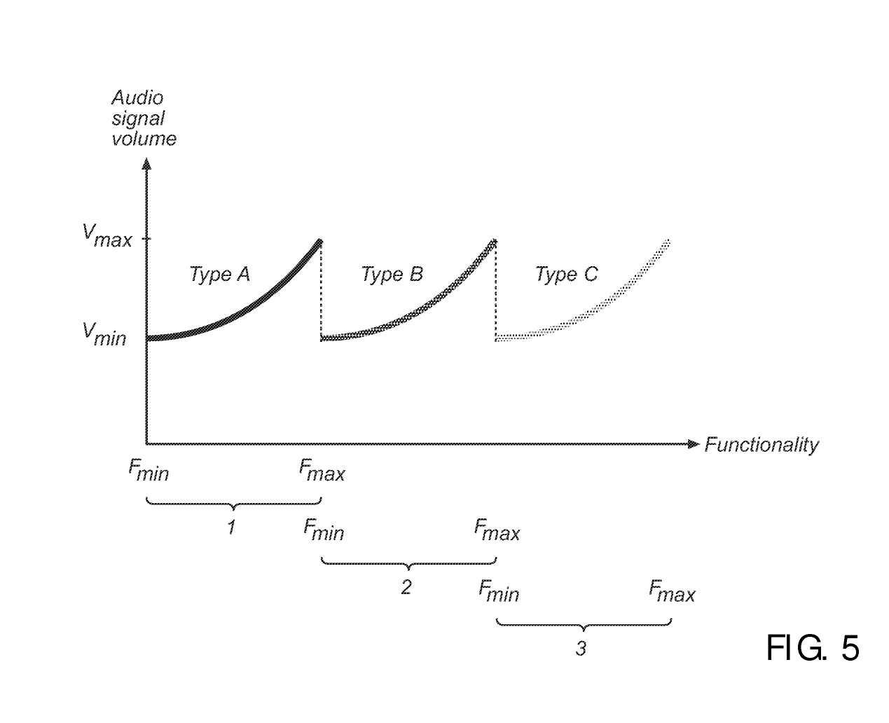

FIG. 5 shows a combination between the type of audio feedback and its volume level as a function of controlled visual parameters. By selecting a first functionality 1 from the control device, a first audio type (Type A) is audible for the user. Although a change of the particular setting within the first functionality 1, ranging from Fₘᵢₙ to Fₘₐₓ, may be performed by tapping/sliding the touch sensitive ring of the control device, the same audio type (Type A) is generated. However, the volume of the audio signal increases exponentially, ranging from Vₘᵢₙ to Vₘₐₓ, as a function of an increase from Fₘᵢₙ to Fₘₐₓ of the functionality. For instance, a user may control a visual parameter such as brightness from very dark to very bright, while the audio transmitter of the control device generates e.g. a permanent beep sound in response thereto. However, the volume of the beep sound increases from Vₘᵢₙ to Vₘₐₓ as the brightness increases from Fₘᵢₙ to Fₘₐₓ. Analogously, a selection of a second functionality 2 from the control device renders a second audio type (Type B), distinguishable from the first audio type. A third functionality 3 renders a third audio type (Type C) distinguishable from the first (Type A) and the second (Type B) audio types. Hence, a change from one functionality to another renders a discontinuous and audibly detectable change in sound type. Each functionality has a distinguishable type of sound whereas the audio feedback volume is a non-linear function of the functionality level setting. The discontinuous change in sound type from one functionality to another informs the user about the functionality change.

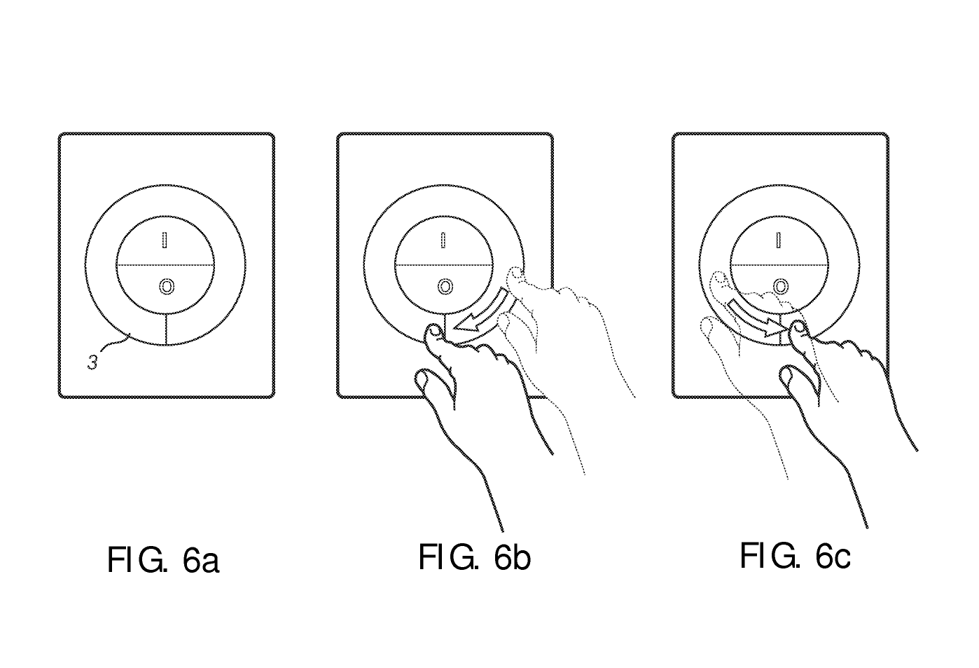

A functionality level setting is shown for a visual parameter such as e.g. brightness in FIG. 6. On the control device 1, the touch-sensitive ring of the user interface 3 has a functionality minimum at the lower left hand side of the ring and a functionality maximum at the lower right hand side of the ring, as shown in FIG. 6a. The interface allows the user to increase the functionality level by a clockwise sliding of a finger over the circular area. Analogously, a functionality level decrease is provided by an anti-clockwise sliding over the circular area. FIG. 6b shows a sliding movement of a user finger from the lower right hand side to the lower left hand side, i.e. a movement from a maximum level setting to a minimum level setting over a sharp transition at the bottom center of the wheel. Here, the control device deactivates the audio feedback whilst keeping the maximum level setting of the functionality active. In the same way, an increase from a minimum to a maximum level setting over the sharp transition at the bottom center of the wheel, as shown in FIG. 6c, the control device deactivates the audio feedback whilst keeping the minimum level setting of the functionality active.

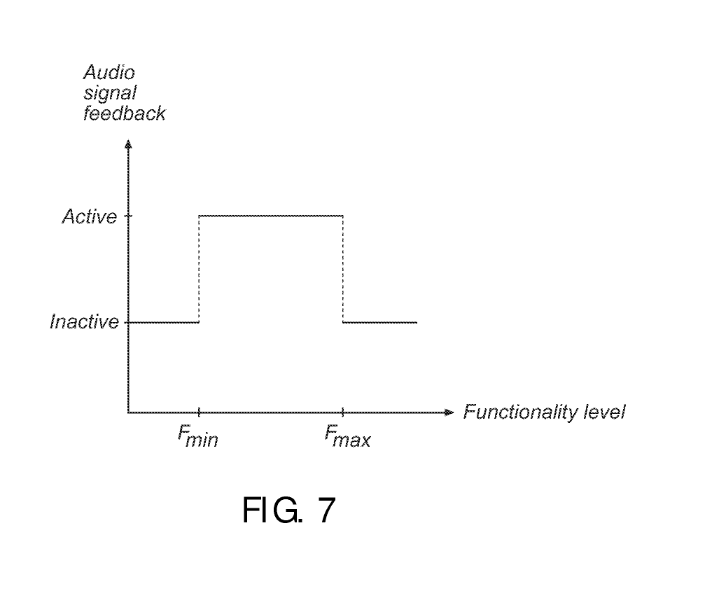

In FIG. 7, the audio signal feedback as a function of functionality level is shown. A user can control the functionality setting between its minimum and maximum value, Fₘᵢₙ and Fₘₐₓ, respectively. The figure shows that in the range

Fₘᵢₙ<=Functionality setting<=Fₘₐₓ,

the audio signal feedback is active. Analogously, the audio signal feedback is inactive

Fₘᵢₙ>Functionality setting or Fₘₐₓ<Functionality setting

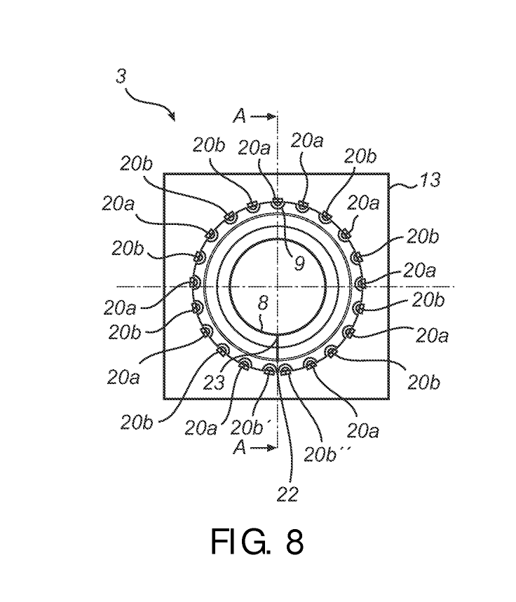

Referring to FIG. 8, the user interface 3 may comprise a substantially circular and approximately planar light guide 8 arranged on a PCB 13 (of which only a portion is shown). The user interface 3 may further comprise a plurality of circumferentially spaced notches 9 (or recesses), each notch 9 (only one notch 9 being referenced by the numeral 9 in FIG. 8) being arranged to be capable of receiving a light-emitting element 20a, 20b that, when received in the respective notch 9 may be substantially radially oriented with respect to the light guide 8. According to the exemplifying illustrated embodiment, the light-emitting elements 20a, 20b comprise LEDs 20a capable of emitting white light and LEDs 20b capable of emitting RGB light, the light-emitting elements 20a, 20b being arranged substantially in a periodic succession of white and RGB LEDs 20a, 20b. However, such a periodic succession is only shown by way of example and other configurations of white LEDs and RBG LEDs, or RGB LEDs only, etc. may be implemented according to user needs and/or application requirements.

According to the exemplifying illustrated embodiment, the light-emitting elements 20a, 20b are circumferentially spaced around the light guide 8 with a spacing that is substantially constant. It is emphasized that FIG. 8 is schematic and the present invention encompasses embodiments comprising arbitrary distances between the circumferentially spaced light-emitting elements 20a, 20b.

The distances between the circumferentially spaced light-emitting elements 20a, 20b need not be the same all around the light guide 8. On the contrary, at least two adjacent light-emitting elements 20b′, 20b″ may be arranged such that the spacing between the two adjacent light-emitting elements 20b′, 20b″ is less than the spacing between other adjacent light-emitting elements of the plurality of light-emitting elements. Such a configuration is shown at the bottom of the light guide 8 in FIG. 8. This may be utilized for increasing the visual contrast at a hard transition, as has been previously discussed.

According to the illustrated embodiment in FIG. 8, such a hard transition may be implemented by means of a discontinuity-forming element 23 arranged in the light guide 8. Hence, the user interface 3 may further comprise a discontinuity-indicating element 23 adapted to visually indicate a step discontinuity in the range of available values representing the at least one property, thus implementing such a hard transition in the range of available values representing the currently activated property represented on the user interface 3. For implementation of such a discontinuity-indicating element 23 there may be arranged a colored region, for example a line 23 according to the illustrated embodiment, in the light guide 8.

The light guide 8 may further comprise a light blocking structure 22, or barrier, between or otherwise being in proximity of a pair of adjacent light-emitting elements 20b′, 20b″ as described in the paragraph immediately above, the light-blocking structure 22 being adapted to substantially block light emitted by light-emitting elements, for further controlling the visual characteristics in proximity of the hard transition.

Even though the invention has been described with reference to specific exemplifying embodiments thereof, many different alterations, modifications and the like will become apparent for those skilled in the art. The described embodiments are therefore not intended to limit the scope of the invention, as defined by the appended claims. For example, a change from a first functionality to a second functionality as shown in FIG. 3 may instead render a continuous change from a first audio signal to a second audio signal. Furthermore, the audio signal feedback volume as a function of functionality level may take on any other relation than those shown in FIG. 4. In fact, any other function establishing a volume change with change of functionality level such that a user may recognize and distinguish said functionality level change, is feasible. Analogously, any other function than the functions presented in FIG. 5, rendering a volume change with change of functionality level to supply the user with feedback, may be feasible. Additionally, a continuous change from a first audio signal to a second audio signal, independently or in combination with any other volume change function, may be feasible.

Moreover, the touch-sensitive ring 5 of the user interface 3 as shown in FIG. 2 may instead have any other form, e.g. a bar or a rectangle, wherein a functionality minimum may be situated in the lower side of the bar and a functionality maximum in the upper side of the bar.

1. A method of providing audio feedback in response to control of visual parameters, the method comprising the steps of:
generating an audio signal in reply to the control of an associated visual parameter among a plurality of visual parameters, a characteristic of which audio signal being arranged such that the signal audibly identifies the controlled visual parameter, and
controlling audio signal volume in response to the particular setting of the controlled visual parameter such that the audio signal volume audibly identifies the particular setting.

2. The method of claim 1, wherein said visual parameters comprise any one of hue, saturation, brightness, color temperature and timing properties.

3. The method of claim 1, wherein the audio signal identifies the controlled visual parameter by means of a particular type of sound such as a click, beep or tick sound, in terms of signal pitch, in terms of signal volume or a combination thereof.

4. (canceled)

5. The method of claim 1, further comprising the step of:
varying the audio signal volume between two extreme values in response to the controlled visual parameter varying between its two extreme values.

6. The method of claim 5, further comprising the step of:
deactivating audio feedback if attempts are made to set the controlled visual parameter to a value outside the range defined by its two extreme values.

7. The method of claim 5, wherein the varying of the audio signal volume is proportional to the varying of the controlled visual parameter value.

8. The method of claim 7, wherein the varying of the audio signal volume is linear with respect to the varying of the controlled visual parameter value.

9. The method of claim 7, wherein the varying of the audio signal volume is non-linear with respect to the varying of the controlled visual parameter value.

10. A control device for providing audio feedback in response to control of visual parameters, said control device comprising:
an audio signal transmitter,
a user interface for controlling the visual parameters,
a communication unit adapted to control the visual parameters by means of communicating control signals effected by said user interface being operated by a user, wherein
the audio signal transmitter transmits an audio signal in reply to the control of an associated visual parameter by means of the user interface being operated, a characteristic of which audio signal being arranged such that the signal audibly identifies the controlled visual parameter, the audio signal volume being controlled in response to the particular setting of the controlled visual parameter such that the audio signal volume audibly identifies the particular setting.

11. The control device of claim 10, wherein the user interface (3) for the control of the visual parameters is touch sensitive.

12. The control device of claim 11, wherein the touch sensitive user interface for the control of the visual parameters is a touch sensitive ring.

13. The control device of claim 10 further comprising:
a plurality of controls, each control being associated with at least one of said visual parameters and being adapted, when operated, to cause said control device to enable the user to control the visual parameter associated with said operated control, wherein audio signal volume audibly identifies the controlled visual parameter.

14. The control device of any claim 11, wherein said touch-sensitive user interface comprises at least one discontinuity-indicating element adapted to visually indicate a step discontinuity in a range of available values representing the activated visual parameter.

15. A computer program product comprising computer-executable components for causing a device to perform the steps recited in claim 1 when the computer-executable components are run on a processing unit included in the device.
